(19) United States
(12) Patent Application Publication
(10) Pub. No.: US 2026/0209015 A1
(43) Pub. Date: Jul. 23, 2026

(54) DEVICE CONTROL METHOD BASED ON ENVIRONMENT INFORMATION

(71) Applicant: BEIJING GEEKPLUS TECHNOLOGY CO., LTD., Beijing (CN)

(72) Inventors: Yulei ZHU, Beijing (CN); Zewei LI, Beijing (CN); Qianli MA, Beijing (CN)

(21) Appl. No.: 19/142,447

(22) PCT Filed: Dec. 5, 2023
(86) PCT No.: PCT/CN2023/136394

§ 371 Date: Jun. 23, 2025

(30) Foreign Application Priority Data
Dec. 29, 2022 (CN) 202211734783.7

(51) Int. Cl. B66F 9/075; G05B 15/02; G06T 7/62; G06T 7/73

(52) U.S. Cl. CPC B66F 9/0755; G05B 15/02; G06T 7/62; G06T 7/74; G06T 2207/10028

(57) ABSTRACT

A device control method based on environment information includes: in response to a received environment information identification instruction, collecting initial environment identification information corresponding to the container handling device, where the container handling device is located in an inventory region, and the initial environment identification information is point cloud data information corresponding to the inventory region; filtering the initial environment identification information to obtain target environment identification information, where the target environment identification information comprises to-be-identified position points; determining a target position point among the to-be-identified position points and target position information corresponding to the target position point; determining target environment information corresponding to the container handling device according to a numeric count of the target position point and the target position information corresponding to the target position point; and determining whether the container handling device is rotatable at the current position according to the target environment information.

### CROSS-REFERENCE TO RELATED APPLICATIONS

This application is a national stage entry under 35 U.S.C. § 371 of International Application PCT/CN2023/136394, filed Dec. 5, 2023, which claims priority to Chinese Patent Application No. 202211734783.7, filed on Dec. 29, 2022, the entire disclosures of which are hereby incorporated herein by reference.

### FIELD

The present disclosure relates to the field of artificial intelligence technology, and in particular to a device control method and apparatus based on environment information.

### BACKGROUND

In warehouses such as logistics warehouses, e-commerce warehouses, pharmaceutical warehouses, and catering warehouses, operations such as storing, picking and transporting goods are usually involved. With the development of science and technology, more and more application fields involve and use the operations of storing, picking and transporting goods performed by automatic handing devices.

### SUMMARY

Embodiments of the present disclosure provide a device control method and apparatus based on environment information.

According to a first aspect of embodiments of the present disclosure, there is provided a device control method based on environment information performed by a container handling device. The method includes: in response to a received environment information identification instruction, collecting initial environment identification information corresponding to the container handling device, where the container handling device is located in an inventory region, and the initial environment identification information is point cloud data information corresponding to the inventory region; filtering the initial environment identification information to obtain target environment identification information, where the target environment identification information includes to-be-identified position points; determining a target position point among the to-be-identified position points and target position information corresponding to the target position point; determining target environment information corresponding to the container handling device according to a numeric count of the target position point and the target position information corresponding to the target position point, where the target environment information is configured to indicate a type of region corresponding to a current position of the container handling device in the inventory region; and determining whether the container handling device is rotatable at the current position according to the target environment information.

According to a second aspect of embodiments of the present disclosure, there is provided a computing device including a memory, a processor and computer instructions stored on the memory and executable on the processor. The processor is configured to perform steps of the device control method based on the environment information when executing the computer instructions.

According to a third aspect of embodiments of the present disclosure, there is provided a non-transitory computer-readable storage medium having stored therein computer instructions that, when executed by a processor, cause the processor to implement the device control method based on the environment information.

### BRIEF DESCRIPTION OF THE DRAWINGS

FIG. 1 is a schematic diagram of a scenario for a device control method based on environment information provided in some embodiments of the present disclosure.

FIG. 2 is a flow chart of a device control method based on environment information provided in some embodiments of the present disclosure.

FIG. 3 is a schematic diagram of initial environment identification information provided in some embodiments of the present disclosure.

FIG. 4 is a flow chart of a device control method based on environment information provided in some other embodiments of the present disclosure.

FIG. 5 is a schematic diagram of a device control apparatus based on environment information provided in some embodiments of the present disclosure.

FIG. 6 is a schematic diagram of a computing device provided in some embodiments of the present disclosure.

### DETAILED DESCRIPTION

Specific details are described in the following description to facilitate a full understanding of the present disclosure. The present disclosure may be implemented in many other ways than those described herein, and those skilled in the art can make similar generalizations without violating the contents of the present disclosure. The present disclosure is not limited by the specific implementation disclosed below.

The terms used in one or more embodiments of the present disclosure are only for the purpose of describing specific embodiments and are not intended to limit the one or more embodiments of the present disclosure. The singular forms “a”, “an” and “the” used in the embodiments of the present disclosure and the appended claims are also intended to include plural forms, unless the context clearly indicates other meanings. It should also be understood that the term “and/or” used herein refers to and includes any or all possible combinations of one or more associated listed items.

It should be understood that although the terms “first”, “second”, etc. may be used to describe various information in the one or more embodiments of the present disclosure, these information should not be limited by these terms. These terms are only used to distinguish same type of information from each other. For example, without departing from the scope of the embodiments of the present disclosure, the first information may also be referred to as the second information, and similarly, the second information may also be referred to as the first information. Depending on the context, the word “if” as used herein may be interpreted as “once” or “when” or “in response to determining”.

Terms involved in one or more embodiments of the present disclosure are explained first.

DBSCAN clustering algorithm refers to Density-Based Spatial Clustering of Applications with Noise.

Region of interest (ROI): in machine vision and image processing, a region to be processed that is outlined in a shape of a square, a circle, an ellipse, or an irregular polygon from a to-be processed image is called the region of interest.

Generally, when a robot (such as a container handling robot) is running in an inventory region in a warehouse, it may need to perform a corresponding rotation action. Due to a size limitation of the robot itself, the robot may not be able to perform the rotation action in a lane or other narrow locations in the inventory region. For example, when a robot in a lane receives a rotation instruction sent by a server, if the robot rotates in the lane according to the rotation instruction, it may cause the robot to collide with shelves on both sides of the lane, causing damage to the robot.

In some examples, when the robot receives a rotation instruction sent by a control device, a radar on the robot may not be able to observe an obstacle such as a shelf near the robot, that is, the rotation obstacle for the robot cannot constrain the robot to rotate in the lane. In this case, when the robot rotates according to the rotation instruction, it may cause the robot to collide with the obstacle such as the shelf, causing damage to the robot, which leads to great risk on safety and stability of the robot. Therefore, there is an urgent need for a method that allows the robot to accurately identify its environment and determine whether it is rotatable according to the environment information.

In order to solve the above problems, the present disclosure provides a device control method based on environment information, a device control apparatus based on environment information, a computing device, and a computer-readable storage medium, which are described in detail one by one in the following embodiments.

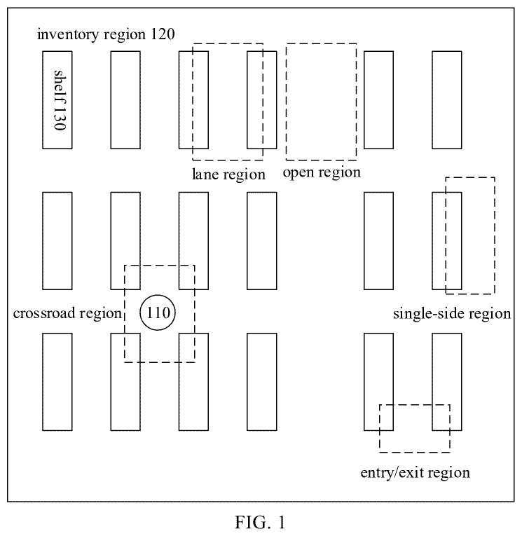

FIG. 1 is a schematic diagram of a scenario of a device control method based on environment information provided by some embodiments of the present disclosure. As shown in FIG. 1, a plurality of shelves 130 are placed in an inventory region 120, and at least one container handling device 110 is running in the inventory region. A numeric count of the container handling device 110 and a numeric count of the shelf 130 are not less than one, and each shelf 130 may include four shelf legs.

In some examples, the plurality of shelves 130 in the inventory region 120 may be placed in a preset arrangement. According to placement positions of the shelves in the inventory region 120, the inventory region 120 may be divided into a plurality of region types.

For example, the inventory region 120 may be divided into a shelf placement region, a lane region, a single-side region, an entry region, an exit region, and an open region, etc., according to the placement positions of the shelves 130. The shelf placement region is a region where the shelves 130 are placed, and other regions are regions where the shelves 130 are not placed. The container handling device 110 may operate in any region except the shelf placement region to perform a corresponding handling task.

As shown in FIG. 1, in the inventory region 120, the regions framed by dashed lines are schematic regions of a crossroad region, a lane region, a single-side region, an entry region, an exit region, and an open region. For example, sizes (such as area sizes) of different regions may be different. When the container handling device 110 is located in different regions, corresponding rotation conditions may be different.

For example, the open region and the crossroad region are relatively large, and when the container handling device 110 performs a rotation action in such two kinds of regions, it will not collide with the shelf 130 placed next to it. The lane region and the single-side region are relatively small, and when the container handling device performs the rotation action in these two kinds of regions, it may collide with the shelf 130 placed next to it, which may cause damage to the device/robot. The entry region and the exit region may allow the container handling device 110 to perform the rotation action, or may not allow the container handling device 110 to perform the rotation action.

In some examples, when the container handling device 110 is moving in the inventory region 120, the rotation action of the container handling device 110 itself may be involved. In order to ensure that the container handling device 110 can avoid an obstacle in the inventory region when performing the rotation action, it needs to accurately identify the environment information of the container handling device 110 in the inventory region 120, so as to determine whether the rotation can be performed based on the environment information.

In some embodiments, laser radars are installed at front and rear of a chassis of the container handling device 110, and the environment information that the laser radars can identify and obtain is numeric count information of shelf legs of shelves 130.

In some embodiments, the target environment information of the container handling device 110 may be determined according to the numeric count of shelf legs of the identified shelves 130, and then it may be determined whether the container handling device 110 is rotatable at a current position. The target environment information may be configured to indicate a type of region corresponding to the current position of the container handling device 110 in the inventory region 120. For example, the target environment information may be used to indicate that the container handling device 110 is located in any of the lane region, the single-side region, the entry region, the exit region, and the open region. As shown in FIG. 1, the container handling device 110 is located in the crossroad region.

The device control method based on environment information provided by the embodiments of the present disclosure collects initial environment identification information of the container handling device in the inventory region, determines a target position point and its corresponding target position information in the initial environment identification information, and further determines the target environment information of the container handling device. By identifying the target environment information of the container handling device, it is determined whether the container handling device is rotatable in the corresponding target environment, thereby improving accuracy for the container handling device to identify the environment information corresponding to the inventory region, accurately avoiding obstacle(s) in the inventory region, ensuring safety of the container handling device when performing the rotation action, and improving stability and efficiency of the operation.

The device control method based on environment information provided by the embodiments of the present disclosure is described in detail below with reference to the accompanying drawings.

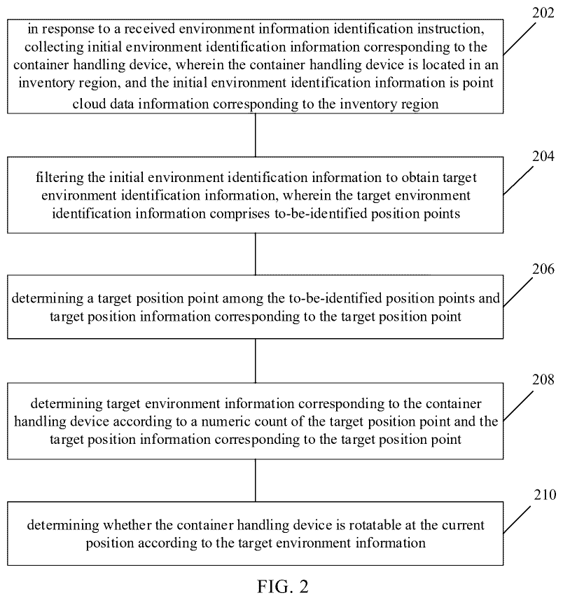

FIG. 2 is a schematic diagram of a device control method based on environment information provided by an embodiment of the present disclosure. As shown in FIG. 2, the method includes the following steps.

In step 202: in response to a received environment information identification instruction, initial environment identification information corresponding to the container handling device is collected. The container handling device is located in an inventory region, and the initial environment identification information is point cloud data information corresponding to the inventory region.

In some examples, the environment information identification instruction refers to an identification instruction for identifying surrounding environment information corresponding to the current position of the container handling device in the inventory region.

For example, the container handling device may be an intelligent device for handling goods, articles, containers, etc. For example, the container handling device may be a container robot, such as an RS robot for picking up and placing a container or the like on a shelf, which is not limited in the embodiments of the present disclosure.

In some examples, laser radars are installed at the front and rear of the chassis of the container handling device, and the laser radars can detect environment information corresponding to the current position of the container handling device, that is, the initial environment information.

In some examples, the initial environment identification information may include point cloud data information of the inventory region. The inventory region may be a region where goods, articles, shelves, etc. are stored, and the inventory region is also a region where the container handling device handles containers, goods, articles, etc. For example, the inventory region may be the inventory region 120 in FIG. 1.

For example, after receiving the environment information identification instruction, the container handling device responds to the environment information identification instruction and collects, with the laser radar(s), the initial environment identification information around the inventory region where the container handling device is located. The initial environment identification information is point cloud data information.

In some examples, the environment information identification instruction may be sent by the control device (such as a server) to the container handling device. For example, the control device may send a rotation instruction to the container handling device to instruct the container handling device to rotate at the current position. After receiving the rotation instruction, the container handling device may collect the environment information corresponding to the current position of the container handling device according to the rotation instruction to obtain the initial environment information corresponding to the container handling device. In this case, the rotation instruction sent by the control device may include an environment information identification instruction. For another example, after sending the rotation instruction to the container handling device, the control device may further send an environment information identification instruction to the container handling device to instruct the container handling device to obtain the corresponding initial environment identification information. The embodiments of the present disclosure are not limited to these examples.

For example, when the container handling device is moving in the inventory region, it may collects information on the shelf legs of the shelves around the container handling device with a lidar installed on the chassis according to the received environment information identification instruction, to obtain point cloud data information corresponding to each shelf leg.

In some examples, due to a limited size of the container handling device and the fact that an area of the inventory region is too large for the container handling device, it needs to set a collection range of the inventory region before collecting the initial environment identification information of the inventory region due to size limitation of the container handling device and performance limitation of the lidar, so that the container handling device may collect data information within the collection range, thus avoiding redundancy of collected data.

In some embodiments, in response to the received environment information identification instruction, collecting the initial environment identification information of the container handling device includes: obtaining an environment collection parameter in the environment information identification instruction; and determining the initial environment identification information corresponding to the container handling device according to the environment collection parameter.

In order to improve the accuracy of the environment identification information, the collection range of the surrounding environment may be pre-set before collecting the initial environment identification information to avoid collecting too much data information and affecting the accuracy of the surrounding environment identification.

For example, the environment collection parameter is configured to indicate the collection range of the container handling device in the inventory region. For example, the environment collection parameter can be a preset collection range that is pre-set before collecting the initial environment identification information. The environment information identification instruction includes the environment collection parameter for indicating the collection range. Therefore, after obtaining the environment information identification instruction, the container handling device may obtain the initial environment identification information within the corresponding collection range according to the environment collection parameter in the environment information identification instruction.

In some examples, the environment collection parameter may be a range of 4 meters in front, behind, left, and right of the container handling device (e.g., the current location of the container handling device).

For example, after receiving the environment information identification instruction, the container handling device first obtains the environment collection parameter(s) carried in the environment information identification instruction, and based on the environment collection parameter(s), obtains the point cloud data information corresponding to the container handling device via the laser radar(s) installed on the chassis of the container handling device.

For example, the environment collection parameter is a preset collection range of 4 meters in front, behind, left and right of the container handling device. When the environment information identification instruction is obtained, the laser radar installed on the chassis of the container handling device is configured to collect point cloud data information within the preset collection range of 4 meters in front, behind, left and right of the container handling device in the inventory region where the container handling device is located.

By setting the environment collection parameter, data redundancy can be avoided in the process of collecting the initial environment identification information, while reducing the collection time of the initial environment identification information and improving the collection efficiency.

In some examples, in order to perform a more accurate analysis on the collected point cloud data, the point cloud data information may be further analyzed by establishing a rectangular coordinate system.

In some embodiments, determining the initial environment identification information corresponding to the container handling device according to the environment collection parameter includes: determining point cloud data information corresponding to the container handling device according to the environment collection parameter; mapping the point cloud data information corresponding to the container handling device to a rectangular coordinate system with the container handling device as an origin, to obtain the initial environment identification information.

In some examples, before collecting the point cloud data of the environment surrounding the container handling device, the rectangular coordinate system may be established with the container handling device as the origin, and the point cloud data collected according to the environment collection parameter may be mapped into the rectangular coordinate system. In other words, the initial environment identification information may include the point cloud data information mapped to the rectangular coordinate system with the container handling device as the origin.

In order to reduce the processing resource and improve the processing efficiency, the rectangular coordinate system with the container handling device as the origin may be established according to the environment collection parameter.

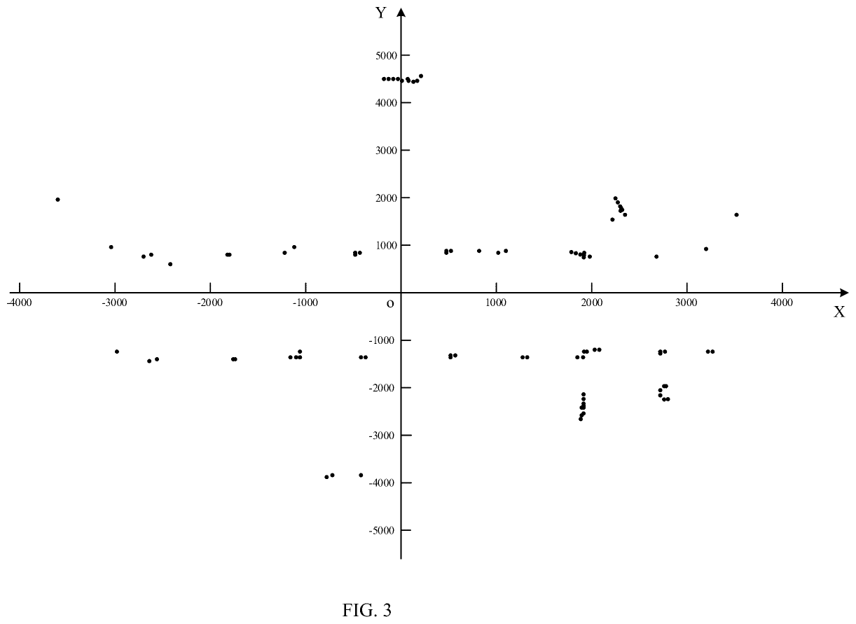

FIG. 3 is a schematic diagram of initial environment identification information provided by an embodiment of the present disclosure. As shown in FIG. 3, the initial environment information includes point cloud data information of the inventory region mapped in a rectangular coordinate system (X-O-Y). In the case where the environment collection parameter is a collection range of 4 meters in front, behind, left and right of the container handling device, the rectangular coordinate system (X-O-Y) as shown in FIG. 3 is established, and the rectangular coordinate system uses the container handling device as the origin, and a size of a range of the X-axis and Y-axis is determined to be 4000 mm*4000 mm according to the environment collection parameter.

The device control method based on the environment information provided by the embodiments of the present disclosure responds to the received environment information identification instruction, collects the initial environment identification information of the container handling device according to the environment collection parameter, and maps the collected initial environment identification information into the rectangular coordinate system with the container handling device as the origin, thus facilitating subsequent processing of the initial environment identification information.

In step 204, the initial environment identification information is filtered to obtain target environment identification information. The target environment identification information includes to-be-identified position points.

In some examples, the target environment identification information is environment identification information after abnormal environment identification information in the initial environment identification information is removed. For example, if the abnormal environment identification information B exists in the initial environment identification information A, the abnormal environment identification information B is removed from the initial environment identification information A to obtain environment identification information C, and the environment identification information C is determined as the target environment identification information.

In some examples, the to-be-identified position point may be a position point that needs to be identified in the target environment identification information. For example, if the target environment identification information C includes position point 1, position point 2, position point 3, position point 4, and position point 5, then position point 1, position point 2, position point 3, position point 4, and position point 5 are all to-be-identified position points.

For example, after obtaining the initial environment identification information, the abnormal environment identification information in the initial environment identification information is eliminated, and the obtained environment identification information is the target environment identification information. Each position point that needs to be identified in the target environment identification information is a to-be-identified position point.

For example, the initial environment identification information collected by the container handling device includes point cloud data information corresponding to the shelf legs, and further includes point cloud data information corresponding to environmental noise in the inventory region. In other words, the initial environment information includes the target environment information and the abnormal environment information. For example, in the initial environment identification information, the target environment identification information is the point cloud data information corresponding to the shelf legs, and the abnormal environment identification information is the point cloud data information corresponding to the environmental noise. Among them, the to-be-identified position point refers to the point cloud data corresponding to each shelf leg in the target environment identification information.

In order to improve the accuracy of the environment information of the container handling device, it needs to remove the point cloud data information corresponding to the environmental noise from the initial environment identification information to obtain the point cloud data information corresponding to the shelf legs, that is, the target environment information.

In some embodiments, filtering the initial environment identification information to obtain the target environment identification information includes: clustering the point cloud data information corresponding to the inventory region to obtain an initial cluster set; determining an abnormal cluster in the initial cluster set, and removing the abnormal cluster from the initial cluster set to obtain a target cluster set; determining a mass center of each target cluster in the target cluster set, and position information corresponding to the mass center of each target cluster; and determining the mass center of each target cluster as a to-be-identified position point, and determining the position information corresponding to the mass center of each target cluster as the position information of the to-be-identified position point.

In some examples, the initial cluster set refers to a cluster set obtained by clustering the point cloud data corresponding to the inventory region. The initial cluster set includes the abnormal cluster. The target cluster set is a cluster set obtained by removing the abnormal cluster from the initial cluster set.

For example, the initial cluster set includes a plurality of clusters, each of which includes at least one point. For example, the initial cluster set may include the abnormal cluster obtained by clustering the point cloud data information corresponding to the environmental noise. Therefore, the abnormal cluster may be removed from the plurality of clusters of the initial clusters to obtain the target cluster set. The target cluster set includes at least one target cluster, and each target cluster is obtained by clustering the point cloud data corresponding to the shelf leg.

For example, a cluster set P1 is obtained after clustering the point cloud data corresponding to the inventory region, and the cluster set P1 is the initial cluster set. If an abnormal cluster p1, an abnormal cluster p2, and an abnormal cluster p3 exist in the initial cluster set P1, then a cluster set after removing the abnormal clusters p1, p2, and p3 from the initial cluster set P1 is the target cluster set P2.

In some examples, the mass center of the target cluster may be determined by an average coordinate position of coordinate positions corresponding to all points in the target cluster in the rectangular coordinate system. For example, the target cluster includes point 1 and point 2. If a coordinate position of point 1 in the rectangular coordinate system is (−1100, 900) and a coordinate position of point 2 in the rectangular coordinate system is (−1000, 900), then a coordinate position corresponding to the mass center of the target cluster is (−1050, 900).

For example, the point cloud data information corresponding to the inventory region is clustered to obtain an initial cluster set, the abnormal cluster is determined in the initial cluster set, the abnormal cluster is removed from the initial cluster set, and the initial cluster set without the abnormal cluster is used as the target cluster set. The mass center of each target cluster is calculated according to the coordinate positions of the points in each target cluster, the mass center of each target cluster is determined as the to-be-identified position point, and the coordinate position corresponding to each mass center is determined as the coordinate position of the to-be-identified position point.

For example, the point cloud data information corresponding to the inventory region is clustered to obtain an initial cluster set P1, abnormal clusters p1, p2, and p3 in the initial cluster set are determined and removed from the initial cluster set P1 to obtain the target cluster set P2. Position point 1 and position point 2 of the target cluster 1 in the target cluster set P2 are determined, and the coordinate position of position point 1 in the rectangular coordinate system is (−1100, 900), and the coordinate position of position point 2 in the rectangular coordinate system is (−1000, 900). Through the coordinate positions (−1100, 900) and (−1000, 900), the coordinate position of the mass center of the target cluster 1 is calculated to be (−1050, 900).

It should be noted that coordinate positions of mass centers of other target clusters can be calculated in the same way. The mass center of each target cluster is determined as the to-be-identified position point, and the coordinate position of the mass center of each target cluster is determined as the position information of the to-be-identified position point.

In some examples, since abnormal cluster may exist in the initial cluster set obtained after clustering, it needs to determine the abnormal cluster in the initial cluster set.

In some embodiments, determining the abnormal cluster in the initial cluster set includes: determine a numeric count of points included in each cluster in the initial cluster set; and determining a cluster in which a numeric count of points is less than a preset number as the abnormal cluster

In some examples, the numeric count of points included in each cluster in the initial cluster set may be the same or different, and the numeric count of points included in each cluster may be one or more.

For example, the preset number may be 2, that is, when the numeric count of points included in a cluster is 1, the cluster corresponding to one point may be determined as an abnormal cluster.

In some embodiments, determining the abnormal cluster in the initial cluster set includes: in the initial cluster set, determining a cluster whose cluster diameter is greater than a preset diameter as the abnormal cluster; and/or in the initial cluster set, determining a cluster having any two points between which an Euclidean distance is greater than a preset threshold as the abnormal cluster.

For example, a cluster diameter of each cluster in the initial cluster set is calculated, and the cluster whose cluster diameter is greater than the preset diameter is determined as the abnormal cluster. For example, the preset diameter may be set to 200 mm, and the cluster whose cluster diameter is greater than 200 mm in the initial cluster set may be determined as the abnormal cluster.

For example, if each cluster in the initial cluster set includes at least two points, the abnormal cluster may be determined according to the Euclidean distance between any two points in each cluster.

In some examples, a cluster in the initial cluster set is obtained, any two points are determined in the cluster, and the Euclidean distance between the two points is calculated. If the Euclidean distance of the cluster is greater than the preset threshold, the cluster is the abnormal cluster. For example, the preset threshold may be set to 200 mm, and a cluster having two points between which the Euclidean distance is greater than 200 mm is the abnormal cluster.

In some examples, if a cluster includes a plurality of points, the Euclidean distance between any two points among the plurality of points may be calculated. When the Euclidean distance between the two points is greater than the preset distance, the cluster in which the two points are located may be determined as the abnormal cluster, and there is no need to calculate the Euclidean distance between other two points in the cluster. When the Euclidean distance between two points is determined as less than or equal to the preset distance, the Euclidean distance between other two points in the cluster may continue to be calculated. If the Euclidean distance between any two points in the cluster is greater than the preset distance, and the cluster is determined as the abnormal cluster; or, if the Euclidean distance between any two points among all points of the cluster is less than or equal to the preset distance, the cluster is determined as the target cluster.

It should be noted that the above methods of calculating the cluster diameter and the Euclidean distance may be used to determine the abnormal cluster in the initial cluster set, and may be used separately or together, which is not limited in the embodiments of the present disclosure.

For example, the point cloud data information corresponding to the inventory region may be clustered by using the DBSCAN clustering algorithm. For example, an Eps parameter and an MmPts parameter of the DBSCAN clustering algorithm are defined respectively, and the clustering operation is performed on the point cloud data information corresponding to the inventory region according to the defined Eps parameter and MmPts parameter.

In some examples, a point being the only one isolated point in the cluster after clustering can be regarded as a noise point, that is, the cluster is an abnormal cluster. For example, an Eps parameter, i.e., a cluster search radius is defined as 150 mm, and an MmPts parameter, i.e., a numeric count of points in the cluster is defined as at least two. Based on the above conditions, the collected point cloud data is density-clustered to obtain the initial cluster set, and an initial cluster with only one isolated point in the initial cluster set is determined as a noise point, which may be a type of abnormal cluster.

For example, by clustering the collected point cloud data information through the DBSCAN clustering algorithm, some abnormal clusters may be identified during clustering to improve processing efficiency.

In some examples, the DBSCAN clustering algorithm may identify the abnormal cluster(s) from the initial cluster set while performing clustering, and may also identify the abnormal cluster(s) in the initial cluster set again after density-clustering is completed, thereby improving the accuracy of identifying the abnormal cluster(s).

The device control method based on the environment information provided by the embodiments of the present disclosure may cluster the point cloud data information through the density clustering algorithm, to identify the abnormal cluster during the clustering process. At the same time, after the clustering is completed, the abnormal cluster existing in the initial cluster set is determined by calculating the cluster diameter or the Euclidean distance of the cluster, which can improve the accuracy of identifying the abnormal cluster and improve the subsequent processing efficiency of the target cluster set.

The device control method based on the environment information provided by the embodiments of the present disclosure filters the initial environment identification information after obtaining the initial environment identification information of the container handling device, so that the abnormal environment identification information can be removed, thereby ensuring the accuracy of subsequent operations based on the target environment identification information. At the same time, by filtering the initial environment identification information, redundancy of processing data information can be avoided, further improving the processing efficiency.

In step 206, among the to-be-identified position points, a target position point and target position information corresponding to the target position point are determined.

In some examples, the target position point is a position point determined among the to-be-identified position points and is used for determining the target environment identification information of the container handling device. The target position information is the position information corresponding to the target position point. For example, the target position information may be the coordinate position of the target position point in the rectangular coordinate system with the container handling device as the origin.

For example, if the to-be-identified position points include to-be-identified position points 1, 2, 3, 4 and 5, among the five to-be-identified position points, to-be-identified position points 1, 3 and 4 are determined as target position points. For example, it may be determined that to-be-identified position point 1 is target position point 1, to-be-identified position point 3 is target position point 2, and to-be-identified position point 4 is target position point 3. Coordinate positions corresponding to to-be-identified position points 1, 3 and 4 are coordinate positions corresponding to target position points 1, 2 and 3, respectively.

In some examples, to identify and determine the environment information around the container handling device, the environment identification information closed to the container handling device needs to be accurately determined. Therefore, among the to-be-identified positions, to-be-identified positions closer to the container handling device may be preferentially selected as target positions.

In order to improve the identification accuracy of the environment surrounding the container handling device, for example, based on geometric features of the inventory region, in the process of determining the target position point among the to-be-identified position points, the target position point can be further determined by the geometric features of the inventory region on the basis of selecting the to-be-identified position points that are closer to the container handling device.

In some embodiments, determining the target position point among the to-be-identified position points and the target position information corresponding to the target position point including: determining a lateral fitting reference line and a longitudinal fitting reference line according to the to-be-identified position point; and determining an intersection point between the lateral fitting reference line and the longitudinal fitting reference line as the target position point, and determining position information corresponding to the intersection point as the target position information.

In some examples, the lateral fitting reference line may be determined according to a travel direction of the container handling device. For example, the lateral fitting reference line may be a fitting reference line generated according to a direction perpendicular to the travel direction of the container handling device.

For example, the rectangular coordinate system may be established with the container handling device as the origin and the travel direction of the container handling device as a positive direction of Y-axis, and the lateral fitting reference line may be a straight line generated by the y value of the to-be-identified position point in the rectangular coordinate system. For example, if a coordinate position of to-be-identified position point 1 is (−1000, 900), the lateral fitting reference line is y=900.

In some examples, the longitudinal fitting reference line may also be determined according to the travel direction of the container handling device. For example, the longitudinal fitting reference line may be a fitting reference line generated in a direction parallel to the travel direction of the container handling device.

For example, the rectangular coordinate system may be established with the container handling device as the origin and the travel direction of the container handling device as the positive direction of the Y-axis, and the longitudinal fitting reference line may be a straight line substantially parallel to the Y-axis of the rectangular coordinate system.

In some examples, the numeric counts of the lateral fitting reference line and the longitudinal fitting reference line may be greater than or equal to 1, that is, one or more lateral fitting reference lines may exist and one or more longitudinal fitting reference lines may exist. Alternatively, there may be no lateral fitting reference line and/or longitudinal fitting reference line.

For example, the corresponding lateral fitting reference line and longitudinal fitting reference line are determined respectively according to the to-be-identified position point, and the intersection point of the lateral fitting reference line and the longitudinal fitting reference line is used as the target position point, and the corresponding coordinate position of the intersection point in the rectangular coordinate system is used as the target position information of the target position point.

In some examples, the determined lateral fitting reference line is y=900, and the longitudinal fitting reference line parallel to the Y-axis is further determined. If the lateral fitting reference line intersects with the longitudinal fitting reference line at to-be-identified position point 1 (−1000, 900) and to-be-identified position point 2 (1000, 900), then to-be-identified position points 1 and 2 may be determined as target position points 1 and 2, and a coordinate position of target position point 1 is (−1000, 900), and a coordinate position of target position point 2 is (1000, 900).

In order to improve the identification of target environment information of the container handling device, the embodiments of the present disclosure may adopt a method of performing region-by-region processing on the target environment identification information corresponding to the inventory region to avoid missing data information in the target environment identification information during the processing.

In some embodiments, determining the lateral fitting reference line according to the to-be-identified position point includes: determining a first region of interest from the target environment identification information; determining a to-be-identified position point located in the first region of interest as a first initial position point in a case where the to-be-identified position point exists in the first region of interest; determining a longitudinal dimension value of the first initial position point; and determining the lateral fitting reference line according to the longitudinal dimension value of the first initial position point.

For example, in the process of identifying and processing the target environment identification information corresponding to the inventory region, in order to improve the accuracy of data processing, the target environment identification information may be processed by region. Therefore, after the initial environment identification information is filtered to obtain the target environment identification information, the target environment identification information is partitioned to obtain a region to be processed, and target environment identification information in such a region can be processed.

In some examples, the first region of interest is configured to indicate a region that needs to be processed in the target environment identification information, and the region is configured to determine the lateral fitting reference line. The first initial position point is a to-be-identified position point included in the first region of interest. The longitudinal dimension value of the first initial position point is the longitudinal coordinate value of the first initial position point in the rectangular coordinate system with the container handling device as the origin.

For example, the first region of interest is determined in the target environment identification information, and the first initial position point in the first region of interest and the coordinate position corresponding to the first initial position point are obtained. Based on the coordinate position corresponding to each first initial position point, the longitudinal dimension value of each first initial position point is recorded, and the corresponding lateral fitting reference line is determined according to the longitudinal dimension value corresponding to each first initial position point.

For example, when determining the first region of interest, a function of Range( ) may be used to divide/partition the target environment identification information. For example, a range of row(s) or column(s) of interest may be specified in the target environment identification information.

For example, first and second rows in the target environment identification information are needed, the function of Range( ) is set as Range(1,2), thus determining that the first region of interest is the first and second rows of the target environment identification information. In an embodiment, a step value of the function of Range(may be pre-set according to requirements. For example, setting the function of Range(as Range(0,6,2) means that from a zeroth row to a sixth row, two rows are stepped each time, that is, a specified row range includes the zeroth row, a second row, a fourth row, and the sixth row. Specific application of Range(may be determined according to an actual application situation, which is not limited herein.

For example, there may be at least one to-be-identified position point in the first region of interest, or there may be no to-be-identified position point. When there is no to-be-identified position point in the first region of interest, it is determined that there is no lateral fitting reference line. When there is at least one to-be-identified position point in the first region of interest, the lateral fitting reference line may be determined according to the numeric count of the to-be-identified position point (i.e., the first initial position point).

In some examples, when the first initial position point is not obtained in the first region of interest, it indicates that in the first region of interest, there is no position point that may be used to identify the target environment identification information of the container handling device, and it may be determined that there is no lateral fitting reference line in the first region of interest.

In some embodiments, determining the lateral fitting reference line according to the longitudinal dimension value of the first initial position point includes: in a case where the numeric count of the first initial position point is one, determining the lateral fitting reference line according to the longitudinal dimension value of the first initial position point; in a case where the numeric count of the first initial position point is at least two, determining at least one lateral fitting reference line according to longitudinal dimension values of the at least two first initial position points.

In some examples, when only one first initial position point is obtained in the first region of interest, it indicates that there is only one position point in the first region of interest that can be used to identify the target environment identification information of the container handling device. In this case, the longitudinal dimension value of the first initial position point is recorded, and the lateral fitting reference line is determined according to the longitudinal dimension value of the first initial position point.

In some examples, when at least two first initial position points are obtained in the first region of interest, it indicates that there are at least two position points in the first region of interest that can be used to identify the target environment identification information of the container handling device. In this case, individual lateral fitting reference lines may be generated according to the at least two first initial position points.

In the embodiments of the present disclosure, the numeric count of the first initial position point in the first region of interest is obtained after partition, and it is further determined whether there is a corresponding lateral fitting reference line according to the numeric count of the first initial position point, thus improving the accuracy of identifying the target environment identification information of the container handling device.

In some embodiments, determining the at least one lateral fitting reference line according to the longitudinal dimension values of the at least two first initial position points includes: ranking the longitudinal dimension value corresponding to each of the at least two first initial position points; determining a difference between longitudinal dimension values of two adjacent first initial position points according to the longitudinal dimension values of the two adjacent first initial position points; in a case where the difference between the longitudinal dimension values is greater than a preset difference, adding the two adjacent first initial position points to two different lateral fitting coordinate point sets, respectively; in a case where the difference between the longitudinal dimension values is less than or equal to the preset difference, adding the adjacent two first initial position points to the same lateral fitting coordinate point set; and determining the lateral fitting reference line according to each lateral fitting coordinate point set.

For example, in the case where at least two first initial position points in the first region of interest are obtained, the corresponding lateral fitting reference line may be determined according to the longitudinal dimension values corresponding to the at least two first initial position points.

In some examples, the preset difference may be a difference between the longitudinal dimension values corresponding to two adjacent first initial position points. The lateral fitting coordinate point set is a set of first initial position points used to generate the lateral fitting reference line.

For example, in the case where at least two first initial position points in the first region of interest are obtained, they are sorted/ranked according to the size of the longitudinal dimension values of individual first initial position points, the difference between the longitudinal dimension values corresponding to any two adjacent first initial position points is calculated, and the calculated difference is compared with the preset difference.

In some examples, if the calculated difference is greater than the preset difference, it indicates that the two adjacent first initial position points are not points in the same row, that is, the two first initial position points are not able to generate the same lateral fitting reference line. Based on this, the two first initial position points need to be added to different lateral fitting coordinate point sets respectively to generate different lateral fitting reference lines.

In some examples, if the calculated difference is less than or equal to the preset difference, it indicates that the two adjacent first initial position points are points in the same row, that is, the two first initial position points are able to generate the same lateral fitting reference line. Based on this, the two first initial position points may be added to the same lateral fitting coordinate point set to generate the same lateral fitting reference line.

Based on the above method, all first initial position points in the first region of interest may be added to corresponding lateral fitting coordinate point set(s), and corresponding lateral fitting reference line(s) may be generated according to the lateral fitting coordinate point set(s).

For example, the preset difference may be set to 200 mm. If a difference between first initial position point 1 and first initial position point 2 is 230 mm (first initial position point 1 is adjacent to first initial position point 2) calculated according to the above method, since 230 mm>200 mm, first initial position point 1 is added to lateral fitting coordinate point set 1, and first initial position point 2 is added to lateral fitting coordinate point set 2. If the difference between first initial position point 2 and first initial position point 3 is 190 mm (first initial position point 2 is adjacent to the first initial position point 3) calculated according to the above method, since 190 mm<200 mm and first initial position point 2 has been added to lateral fitting coordinate point set 2, first initial position point 3 may be added to lateral fitting coordinate point set 2. Lateral fitting coordinate point set 1 and lateral fitting coordinate point set 2 are different sets.

By calculating the difference between the longitudinal dimension values corresponding to every two adjacent first initial position points and comparing the difference with the preset difference, the lateral fitting coordinate point set(s) to which every first initial position point belongs is determined, and the corresponding lateral fitting reference line(s) may be generated according to each lateral fitting coordinate point set.

In some embodiments, determining the lateral fitting reference line according to each lateral fitting coordinate point set includes: determining a target lateral fitting coordinate point according to each lateral fitting coordinate point set; obtaining respective longitudinal dimension values of first initial position points in the target lateral fitting coordinate point set; determining an average value of the longitudinal dimension values of the first initial position points according to the longitudinal dimension values of the first initial position points; and determining the lateral fitting reference line corresponding to the target lateral fitting coordinate point set according to the average value.

In some examples, the target lateral fitting coordinate point set is a lateral fitting coordinate point set that needs to generate a corresponding lateral fitting reference line, and the lateral fitting coordinate point set may include the target lateral fitting coordinate point set. For example, among lateral fitting coordinate point sets 1, 2, and 3, a lateral fitting reference line corresponding to lateral fitting coordinate point set 2 needs to be generated, and lateral fitting coordinate point set 2 is the target lateral fitting coordinate point set.

For example, in process of generating a lateral fitting reference line according to a corresponding lateral fitting coordinate point set, the lateral fitting coordinate point set corresponding to the lateral fitting reference line to be generated is determined, that is, the target lateral fitting coordinate point set is determined, the longitudinal dimension value corresponding to each first initial position point in the target lateral fitting coordinate point set is obtained, based on the longitudinal dimension value corresponding to each first initial position point, the average value among these longitudinal dimension values are calculated, and the corresponding lateral fitting reference line according to the calculated average value is generated.

For example, in the above example, if the lateral fitting reference line corresponding to lateral fitting coordinate point set 2 needs to be generated, lateral fitting coordinate point set 2 {first initial position point 2, first initial position point 3} is obtained as the target lateral fitting coordinate point set, and the longitudinal dimension values corresponding to first initial position point 2 and first initial position point 3 in lateral fitting coordinate point set 2 {first initial position point 2, first initial position point 3} are obtained as 1000 and 1190, respectively, and the average value of the longitudinal dimension values corresponding to first initial position points 2 and 3 is calculated to be 1095, and the lateral fitting reference line corresponding to lateral fitting coordinate point set 2 is generated, according to the average value 1095 of the longitudinal dimension values corresponding to first initial position point 2 and first initial position point 3, as y=1095.

It should be noted that there may be an error in the position information corresponding to the identified first initial position points. With the above method, the average value of the respective longitudinal dimension values corresponding to the first initial position points is calculated to generate the lateral fitting reference line corresponding to the lateral fitting coordinate point set. This can reduce the error in generating the lateral fitting reference line and further preliminarily determine the target environment information of the container handling device according to the average value of the longitudinal dimension value.

In some examples, after calculating the average value of the longitudinal dimension values corresponding to the first initial position points, it is also possible to not generate the corresponding lateral fitting reference line, and the calculated average value may be used for subsequent preliminary determination of the target environment information of the container handling device. In this case, the target position point may be determined according to the generated longitudinal fitting reference line and the respective first initial position point. For example, the first initial position point that intersects with the longitudinal fitting reference line is determined as the target position point, and the position information of the first initial position point that intersects with the longitudinal fitting reference line is the target position information.

The above two methods may be further determined according to actual conditions, which are not limited in the present disclosure.

In some embodiments, after generating the lateral fitting reference line corresponding to the target lateral fitting coordinate point set according to the average value, the method further includes: in a case where two lateral fitting reference lines are generated, obtaining average values corresponding to the two lateral fitting reference lines; in a case where the average values corresponding to the two lateral fitting reference lines have the same sign, determining that the two lateral fitting reference lines are located at the same side of the container handling device; in a case where the average values corresponding to the two lateral fitting reference lines have different signs, determining that the two lateral fitting reference lines are respectively located at different sides of the container handling device.

In other words, in some embodiments, determining the lateral fitting reference line corresponding to the target lateral fitting coordinate point set according to the average value includes: generating a candidate lateral fitting reference line according to the average value; in a case where a plurality of candidate lateral fitting reference lines are generated, obtaining average values corresponding to the plurality of candidate lateral fitting reference lines; in a case where the average values corresponding to two candidate lateral fitting reference lines among the plurality of candidate lateral fitting reference lines have the same sign, determining that the two candidate lateral fitting reference lines are located at the same side of the container handling device, and determining the lateral fitting reference line from the two candidate lateral fitting reference lines; in a case where the average values corresponding to two candidate lateral fitting reference lines among the plurality of candidate lateral fitting reference lines have opposite signs, determining that the two candidate lateral fitting reference lines are located at different sides of the container handling device, respectively, and determining the two candidate lateral fitting reference lines as the lateral fitting reference lines.

In some examples, after calculating the average value of the longitudinal dimension values corresponding to the first initial position points, the target environment information of the container handling device may be preliminarily determined according to the positive or negative value of the average value.

For example, if two lateral fitting reference lines are generated, the corresponding average values of the two lateral fitting reference lines are obtained. Since the rectangular coordinate system is established with the container handling device as the origin, if the average values corresponding to the two lateral fitting reference lines have the same sign, it indicates that the two lateral fitting reference lines are located at the same side of the container handling device. In this case, the lateral fitting reference line closest to the container handling device can be determined according to the average values. If the average values corresponding to the two lateral fitting reference lines have different signs, it indicates that the two lateral fitting reference lines are located on different sides of the container handling device, respectively. In this case, the two lateral fitting reference lines closest to the container handling device can be directly determined.

By calculating the average value of the longitudinal dimension values corresponding to the first initial position points, the target environment information of the container handling device may be preliminarily determined, which may improve the processing efficiency and shorten the operation process.

In some embodiments, determining the longitudinal fitting reference line according to the to-be-identified position point includes: determining a second region of interest from the target environment identification information; in a case where at least two to-be-identified position points exist in the second region of interest, determining the to-be-identified position points located in the second region of interest as second initial position points; in a case where a numeric count of the second initial position points is two, determining the longitudinal fitting reference line according to a line connecting the two second initial position points; in a case where the numeric count of the second initial position points is greater than two, determining the longitudinal fitting reference line by a linear fitting algorithm according to respective longitudinal dimension values corresponding to the second initial position points.

In some examples, the second region of interest is configured to indicate a region that needs to be processed in the target environment identification information, and the region is configured to determine the longitudinal fitting reference line. For example, the first region of interest and the second region of interest may be the same processing region or different processing regions. The second initial position point is specifically a to-be-identified position point in the second region of interest.

In some examples, the straight line fitting algorithm is configured to indicate a fitting algorithm for fitting the second initial position points in the second region of interest into a straight line. For example, the straight line fitting algorithm may be least square method, Hough transform algorithm, or the like.

For example, the second region of interest is determined in the target environment identification information, and second initial position point(s) in the second region of interest is obtained. Based on the numeric count of the second initial position point, a straight line fitting algorithm for generating a longitudinal fitting reference line is determined, and a corresponding longitudinal fitting reference line is generated according to the determined straight line fitting algorithm.

It should be noted that the method for determining the second region of interest is similar to that for determining the first region of interest. When determining the second region of interest, the function of Range( ) may also be used to partition the target environment identification information. For example, a range of rows or columns of interest may be specified in the target environment identification information. Specific implementation method may refer to the method for determining the first region of interest, which will not be elaborated here to avoid repetition.

For example, if the numeric count of the to-be-identified position point included in the second region of interest is less than two, there is no longitudinal fitting reference line.

In some examples, if there is no to-be-identified position point in the second ROI, it indicates that there is no position point in the second ROI that can be used to identify the target environment identification information of the container handling device, and it can be determined that there is no longitudinal fitting reference line in the second ROI.

In other examples, if there is a to-be-identified position point in the second region of interest, it can be considered that the container handling device is located in a corner region of the inventory region, and a distance between the container handling device and the second initial position point is far. The second initial position point does not affect the movement process of the container handling device. Therefore, it can be determined that there is no longitudinal fitting reference line in the second region of interest.

In some examples, if there are two to-be-identified position points (i.e., two second initial position points) in the second region of interest, since a straight line is determined by the two points, the two second initial position points can be directly connected to generate a corresponding longitudinal fitting reference line.

In some examples, if there are more than two to-be-identified position points in the second region of interest (i.e., the numeric count of the second initial position points is greater than two), a straight line fitting can be performed on the obtained second initial position points based on the straight line fitting algorithm. For example, least square method or Hough transform algorithm is used to obtain a corresponding longitudinal fitting reference line.

For example, the least square method is used, and a coordinate position corresponding to each second initial position point obtained is put into the following formula (1) for calculation to obtain the corresponding longitudinal fitting reference line:

$$y = a x + b \qquad Formla ( 1 )$$

where, in formula (1), x represents a lateral dimension value (i.e., x coordinate) of a second initial position point, y represents a longitudinal dimension value (i.e., y coordinate) of a second initial position point, a represents a slope of the longitudinal fitting reference line, and b represents an intercept of the longitudinal fitting reference line.

The device control method based on the environment information provided by the embodiments of the present disclosure is beneficial to improving identification efficiency and accuracy of the subsequent determination of the target environment information of the container handling device by determining the target position point among the to-be-identified position points and obtaining the target position information corresponding to the target position point.

In step 208, target environment information corresponding to the container handling device is determined according to a numeric count of the target position point and the target position information corresponding to the target position point.

The target environment information is environment information surrounding the container handling device in the inventory region that affects the movement of the container handling device.

For example, the target environment information may be determined according to the numeric count of target position points. The target environment information corresponding to the container handling device may be different depending on the numeric count of target position points. In some examples, the target environment information may be one of a lane region, a crossroad region, an entry region, an exit region, a single-side region, and an open region.

For example, when the numeric count of the target position point is 4, that is, the numeric count of the shelf leg that affects the movement of the container handling device is 4. In this case, the target environment information corresponding to the container handling device is the lane region or the crossroad region. When the numeric count of the target position point is 2, that is, the numeric count of the shelf leg that affects the movement of the container handling device is 2. In this case, the target environment information corresponding to the container handling device is the entry region, the exit region, or the single-side region. When the numeric count of the target position point is 0, that is, the numeric count of the shelf leg that affects the movement of the container handling device is 0. In this case, the target environment information of the container handling device is an open region.

In some embodiments, determining the target environment information corresponding to the container handling device according to the numeric count of the target position point and the target position information corresponding to the target position point includes: in a case where the numeric count of the target position point is four, determining a perimeter of a geometric figure composed of the four target position points according to target position information corresponding to the four target position points; in a case where the perimeter of the geometric figure meets a preset perimeter, determining that the container handling device is in a lane region; in a case where the perimeter of the geometric figure does not meet the preset perimeter, determining that the container handling device is in a crossroad region.

In some examples, the preset perimeter refers to a perimeter of a geometric figure formed by connecting four preset target position points. For example, the perimeter of the geometric figure meeting the preset perimeter may include that the perimeter of the geometric figure is less than or equal to the preset perimeter; and the perimeter of the geometric figure not meeting the preset perimeter may include that the perimeter of the geometric figure is greater than the preset perimeter.

For example, after obtaining four target position points and the target position information corresponding to the four target position points, an actual perimeter of a geometric figure formed by the four target position points may be calculated according to the target position information corresponding to the four target position points. The target environment information of the container handling device is determined according to the actual perimeter of the geometric figure formed by the four target position points and the preset perimeter.

For example, the four target points are target point 1, target point 2, target point 3 and target point 4, a coordinate position of target point 1 is (−500, 900), a coordinate position of target point 2 is (−500, −1100), a coordinate position of target point 3 is (500, 900), and a coordinate position of target point 4 is (500, −1100). According to the corresponding coordinate positions of target point 1, target point 2, target point 3 and target point 4, a perimeter of a closed geometric FIG. 1-2-4-3 composed of target point 1, target point 2, target point 3 and target point 4 is calculated to be 6000 mm.

In some examples, if the preset perimeter is 6000 mm, the perimeter of the closed geometric FIG. 1-2-4-3 composed of the four target position points is equal to the preset perimeter, that is, the perimeter of the closed geometric FIG. 1-2-4-3 meets the preset perimeter. In this case, it can be determined that the container handling device is in the lane region. Since the range of the lane region is relatively narrow compared to the container handling device, the container handling device is not rotatable in the lane region.

In other examples, if the preset perimeter is 5000 mm, the perimeter of the closed geometric FIG. 1-2-4-3 composed of the four target position points is 6000 mm, which is greater than the preset perimeter, that is, the perimeter of the closed geometric FIG. 1-2-4-3 does not meet the preset perimeter. In this case, it can be determined that the container handling device is in the crossroad region. Since the scope of the crossroad region is relatively wide compared to the container handling device, the container handling device is rotatable in the crossroad region.

In some embodiments, determining the target environment information corresponding to the container handling device according to the numeric count of the target position point and the target position information corresponding to the target position point includes: in a case where the numeric count of the target position point is two, obtaining a travel direction of the container handling device; based on the travel direction of the container handling device and target position information corresponding to the two target position points, determining a positional relationship between each of the two target position points and the container handling device; in a case where both of the two target position points are located at one side of the container handling device, determining that the container handling device is in a single-side region; in a case where both of the two target position points are located in front of the container handling device, determining that the container handling device is in an entry region; in a case where both of the two target position points are located behind the container handling device, determining that the container handling device is in an exit region.

For example, in the case of obtaining two target position points, the travel direction of the container handling device needs to be further obtained, to determine the positional relationship between the two obtained target position points and the container handling device.

For example, according to the travel direction of the container handling device, specific positions of the two obtained target position points with respect to the container handling device are further determined. For example, the two target position points may be located at the side, front, or rear of the container handling device. The side includes a left or right side of the container handling device.

In some examples, if the two target positions are located at one side of the container handling device, it indicates that target position points exist only at one side of the container handling device. In this case, it may be determined that the container handling device is in the single-side region. Since a distance between the target position and the container handling device in the single-side region is small, the container handling device is not rotatable when it is in the single-side region.

In some examples, if the two target position points are located in front of the container handling device, it indicates that the target position points exist only in front of the container handling device. In this case, if it is determined that the container handling device is about to enter the front region according to the travel direction of the container handling device, it may be determined that the container handling device is in the entry region. In this case, a distance from the container handling device to a connecting line between the two target position points is further calculated. If the connecting line distance is greater than a rotation radius of the container handling device, the container handling device is rotatable in the entry region, otherwise it is not rotatable in the entry region.

In some examples, if the two target position points are located behind the container handling device, it indicates that the target position points exist only in rear of the container handling device. In this case, if it is determined that the container handling device is about to exit the rear region according to the travel direction of the container handling device, it may be determined that the container handling device is in the exit region. In this case, a distance from the container handling device to a connecting line between the two target position points. If the connecting line distance is greater than the rotation radius of the container handling device, the container handling device is rotatable in the exit region, otherwise it is not rotatable in the exit region.

In some embodiments, determining the target environment information corresponding to the container handling device according to the numeric count of the target position point and the target position information corresponding to the target position point includes: in a case where the target position point is not obtained or the numeric count of the target position point is one, determining that the container handling device is in an open region.

For example, if the target position point is not obtained or one target position point is obtained, it indicates that within the range where the container handling device can move, there is no target position point that affects the movement of the container handling device. In this case, it can be determined that the container handling device is in the open region of the inventory region. Since there is no obstacle that affects the container handling device in the open region, the container handling device is rotatable in the open region.

In the device control method based on the environment information provided by the embodiments of the present disclosure, by identifying the target environment information of the target environment in which the container handling device is located, it is conducive to enabling the container handling device to further determine whether the container handling device is rotatable in the corresponding target environment according to the identified target environment information.

In step 210, it is determined whether the container handling device is rotatable at the current position according to the target environment information.

For example, after obtaining the target environment information corresponding to the target environment in which the container handling device is located, a specific region position of the container handling device in the inventory region may be determined according to the target environment information, such as the entry region, the exit region, the lane region, or the crossroad region, and the container handling device may determine whether it is rotatable according to its region position.

In some embodiments, the target environment information includes any one of the lane region, the crossroad region, the single-side region, the entry region, the exit region, and the open region.

In some embodiments, determining whether the container handling device is rotatable according to the target environment information includes: in a case where the target environment information is a crossroad region or an open region, determining that the container handling device is rotatable at the current position; in a case where the target environment information is a lane region or a single-side region, determining that the container handling device is not rotatable at the current position; in a case where the target environment information is an entry region or an exit region, determining a target distance between the container handling device and a line connecting two target position points; and determining that the container handling device is rotatable at the current position in a case where the target distance is greater than a rotation radius of the container handling device; or determining that the container handling device is not rotatable at the current position in a case where the target distance is less than the rotation radius of the container handling device.

For example, in a case where it is determined according to the target environment information that the container handling device is in the lane region of the inventory region, the lane region is relatively narrow and small compared to the container handling device, so the container handling device is not rotatable in this case. In a case where the container handling device is in the crossroad region of the inventory region, the crossroad region is relatively wide compared to the container handling device, so the container handling device is rotatable in this case. In a case where the container handling device is in the single-side region of the inventory region, since a distance between the target position point and the container handling device is small, the container handling device is not rotatable when it is in the single-side region. In a case where the container handling device is in the entry region of the inventory region, a distance from the container handling device to a line connecting the two target position points is further calculated. If the distance from the container handling device to the line connecting the two target position points is greater than the rotation radius of the container handling device, the container handling device is rotatable, otherwise it is not rotatable. In a case where the container handling device is in the exit region of the inventory region, a distance from the container handling device to a line connecting the two target position points is further calculated. If the distance from the container handling device to the line connecting the two target position points is greater than the rotation radius of the container handling device, the container handling device is rotatable, otherwise it is not rotatable. In a case where the container handling device is in the open region of the inventory region, the container handling device is rotatable.

The device control method based on the environment information provided by the embodiments of the present disclosure is applied to container handling device, and includes: in response to the received environment information identification instruction, collecting the initial environment identification information corresponding to the container handling device, where the container handling device is located in the inventory region, and the initial environment identification information is the point cloud data information corresponding to the inventory region; filtering the initial environment identification information to obtain the target environment identification information, where the target environment identification information includes to-be-identified position points; determining the target position point among the to-be-identified position points and the target position information corresponding to the target position point; determining target environment information corresponding to the container handling device according to the numeric count of the target position point and the target position information corresponding to the target position point; and determining whether the container handling device is rotatable at the current position according to the target environment information.

In the device control method based on the environment information provided by the embodiments of the present disclosure, by collecting the initial environment identification information of the container handling device in the inventory region, the target position point and its corresponding target position information in the initial environment identification information are determined, and the target environment information of the container handling device is further determined. By identifying the target environment information of the container handling device, it is determined whether the container handling device is rotatable in the corresponding target environment, thereby compensating for the deficiency of the container handling device performing a single rotation in actual applications, effectively improving the safety of the container handling device when performing the rotation action, and further improving the stability and safety of the operation.

In some embodiments, after determining whether the container handling device is rotatable at the current position, the method further includes: in a case where it is determined that the container handling device is rotatable at the current position, performing rotating at the current position; in a case where it is determined that the container handling device is not rotatable at the current position, generating alarm information and/or a fault instruction, where the fault instruction is configured to indicate that the container handling device is not rotatable at the current position.

In some examples, when it is determined that the container handling device is not rotatable at the current position, the container handling device may generate the alarm information to prompt a staff that the rotation action cannot be performed at the current position so that the staff can solve the rotation problem of the container handling device.

In some examples, when it is determined that the container handling device is not rotatable at the current position, the container handling device may generate an alarm instruction and send the alarm instruction to the control device. After receiving the alarm instruction, the control device may obtain information that the container handling device is not rotatable at the current position and update the position information, thereby avoiding sending an instruction to the container handling device to rotate at the current position in subsequent operation. Alternatively, after receiving the alarm instruction, the control device may send another rotation instruction to the container handling device to instruct the container handling device to run to another position to perform the rotation action. It should be noted that when the container handling device reaches the other position, it can further determine whether it is rotatable at the other position according to the device control method based on the environment information provided in the above embodiments.

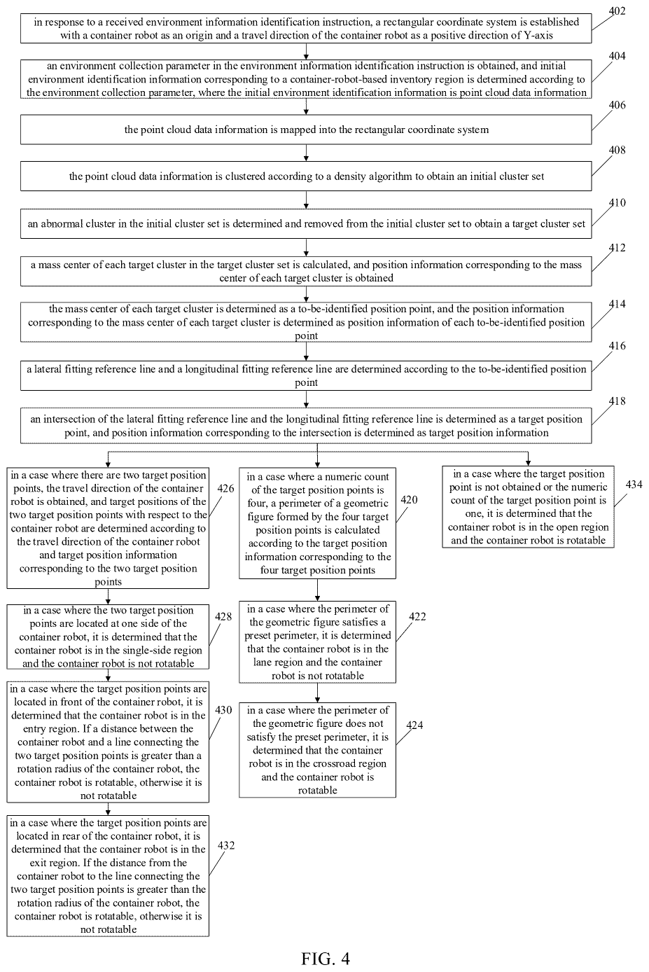

FIG. 4 is a flow chart of a device control method based on environment information provided in some other embodiments of the present disclosure. With reference to FIG. 4, the device control method based on the environment information provided by the present disclosure is further described in a case where the device control method based on the environment information is applied in goods handling. As shown in FIG. 4, the device control method based on the environment information may include the following steps.

In step 402, in response to a received environment information identification instruction, a rectangular coordinate system is established with a container robot as an origin and a travel direction of the container robot as a positive direction of Y-axis.

In step 404, an environment collection parameter in the environment information identification instruction is obtained, and initial environment identification information corresponding to a container-robot-based inventory region is determined according to the environment collection parameter, where the initial environment identification information is point cloud data information.

In step 406, the point cloud data information is mapped into the rectangular coordinate system.

In step 408, the point cloud data information is clustered according to a density algorithm to obtain an initial cluster set.

In step 410, an abnormal cluster in the initial cluster set is determined and removed from the initial cluster set to obtain a target cluster set.

In step 412, a mass center of each target cluster in the target cluster set is calculated, and position information corresponding to the mass center of each target cluster is obtained.

In step 414, the mass center of each target cluster is determined as a to-be-identified position point, and the position information corresponding to the mass center of each target cluster is determined as position information of each to-be-identified position point.

In step 416, a lateral fitting reference line and a longitudinal fitting reference line are determined according to the to-be-identified position point.

In step 418, an intersection of the lateral fitting reference line and the longitudinal fitting reference line is determined as a target position point, and position information corresponding to the intersection is determined as target position information.

In step 420, in a case where a numeric count of the target position points is four, a perimeter of a geometric figure formed by the four target position points is calculated according to the target position information corresponding to the four target position points.

In step 422, in a case where the perimeter of the geometric figure satisfies a preset perimeter, it is determined that the container robot is in the lane region and the container robot is not rotatable.

In step 424, in a case where the perimeter of the geometric figure does not satisfy the preset perimeter, it is determined that the container robot is in the crossroad region and the container robot is rotatable.

In step 426, in a case where there are two target position points, the travel direction of the container robot is obtained, and target positions of the two target position points with respect to the container robot are determined according to the travel direction of the container robot and target position information corresponding to the two target position points.

In step 428, in a case where the two target position points are located at one side of the container robot, it is determined that the container robot is in the single-side region and the container robot is not rotatable.

In step 430, in a case where the target position points are located in front of the container robot, it is determined that the container robot is in the entry region. If a distance between the container robot and a line connecting the two target position points is greater than a rotation radius of the container robot, the container robot is rotatable, otherwise it is not rotatable.

In step 432, in a case where the target position points are located in rear of the container robot, it is determined that the container robot is in the exit region. If the distance from the container robot to the line connecting the two target position points is greater than the rotation radius of the container robot, the container robot is rotatable, otherwise it is not rotatable.

In step 434, in a case where the target position point is not obtained or the numeric count of the target position point is one, it is determined that the container robot is in the open region and the container robot is rotatable.

It should be noted that steps 402 to 434 may refer to the above embodiments (such as steps 202 to 210), and will not be elaborated here.

With the device control method based on the environment information provided by the embodiments of the present disclosure, by identifying the target environment information of the container robot, it is further determined whether the container robot is rotatable in the corresponding target environment, thereby compensating for the deficiency of the container robot performing a single rotation in actual applications, effectively improving the safety of the container handling device when performing the rotation action, and further improving the stability and safety of the operation.

Corresponding to the above method embodiments, embodiments of the present disclosure further provide a device control apparatus based on environment information. FIG. 5 is a schematic diagram of a device control apparatus based on environment information provided in some embodiments of the present disclosure. For example, the apparatus may be applied to a container handling device. As shown in FIG. 5, the apparatus includes a collecting module 502, a filtering module 504, a first determination module 506, a second determination module 508, and a third determination module 510.

The collecting module 502 is configured to, in response to a received environment information identification instruction, collect initial environment identification information corresponding to the container handling device, where the container handling device is located in an inventory region, and the initial environment identification information is point cloud data information corresponding to the inventory region.

The filtering module 504 is configured to filter the initial environment identification information to obtain target environment identification information, where the target environment identification information includes to-be-identified position points.

The first determining module 506 is configured to determine a target position point among the to-be-identified position points and target position information corresponding to the target position point.

The second determining module 508 is configured to determine target environment information corresponding to the container handling device according to a numeric count of the target position point and the target position information corresponding to the target position point, where the target environment information is configured to indicate a type of region corresponding to a current position of the container handling device in the inventory region.

The third determining module 510 is configured to determine whether the container handling device is rotatable at the current position according to the target environment information.

In some embodiments, the collecting module 502 is further configured to determine an environment collection parameter in the environment information identification instruction, where the environment collection parameter is configured to indicate to the container handling device a collection range in the inventory region; and determine, according to the environment collection parameter, the initial environment identification information corresponding to the container handling device.

In some embodiments, the collecting module 502 is further configured to determine, according to the environment collection parameter, point cloud data information corresponding to the container handling device; and map the point cloud data information corresponding to the container handling device to a rectangular coordinate system with the container handling device as an origin, to obtain the initial environment identification information.

In some embodiments, the filtering module 504 is further configured to cluster the point cloud data information corresponding to the inventory region to obtain an initial cluster set, where the initial cluster set includes a plurality of clusters, each of which includes at least one point; determine an abnormal cluster among the plurality of clusters in the initial cluster set, and remove the abnormal cluster from the initial cluster set to obtain a target cluster set; determine a mass center of each target cluster in the target cluster set, and position information corresponding to the mass center of each target cluster; and determine the mass center of each target cluster as a to-be-identified position point, and determine the position information corresponding to the mass center of each target cluster as the position information of the to-be-identified position point.

In some embodiments, the filtering module 504 is further configured to determine a numeric count of points included in each cluster in the initial cluster set; and determine a cluster in which a numeric count of points is less than a preset number as the abnormal cluster.

In some embodiments, the filtering module 504 is further configured to determine, among the plurality of clusters included in the initial cluster set, a cluster whose cluster diameter is larger than a preset diameter as the abnormal cluster; and/or determine an Euclidean distance between any two points in each cluster, and determine, among the plurality of clusters included in the initial cluster set, a cluster corresponding to two points between which an Euclidean distance is greater than a preset threshold as the abnormal cluster.

In some embodiments, the first determining module 506 is further configured to determine a lateral fitting reference line and a longitudinal fitting reference line according to the to-be-identified position point; and determine an intersection point of the lateral fitting reference line and the longitudinal fitting reference line as the target position point, and determine position information corresponding to the intersection point as the target position information.

In some embodiments, the first determining module 506 is further configured to determine a first region of interest from the target environment identification information; determine a to-be-identified position point located in the first region of interest as a first initial position point in a case where the to-be-identified position point exists in the first region of interest; determine a longitudinal dimension value of the first initial position point; and determine the lateral fitting reference line according to the longitudinal dimension value of the first initial position point.

In some embodiments, the first determining module 506 is further configured to, in a case where a numeric count of the first initial position point is one, determine the lateral fitting reference line according to the longitudinal dimension value of the first initial position point; in a case where the numeric count of the first initial position point is at least two, determine at least one lateral fitting reference line according to longitudinal dimension values of the at least two first initial position points.

In some embodiments, the first determining module 506 is further configured to rank the longitudinal dimension value corresponding to each of the at least two first initial position points; determine a difference between longitudinal dimension values of two adjacent first initial position points according to the longitudinal dimension values of the two adjacent first initial position points; in a case where the difference between the longitudinal dimension values is greater than a preset difference, add the two adjacent first initial position points to two different lateral fitting coordinate point sets, respectively; in a case where the difference between the longitudinal dimension values is less than or equal to the preset difference, add the two adjacent first initial position points to the same lateral fitting coordinate point set; and determine the lateral fitting reference line according to each lateral fitting coordinate point set.

In some embodiments, the first determining module 506 is further configured to determine a target lateral fitting coordinate point set according to each lateral fitting coordinate point set; obtain respective longitudinal dimension values of first initial position points in the target lateral fitting coordinate point set; determine an average value of the longitudinal dimension values of the first initial position points according to the longitudinal dimension values of the first initial position points; and determine the lateral fitting reference line corresponding to the target lateral fitting coordinate point set according to the average value.

In some embodiments, the first determining module 506 is further configured to generate a candidate lateral fitting reference line according to the average value; in a case where a plurality of candidate lateral fitting reference lines are generated, obtain average values corresponding to the plurality of candidate lateral fitting reference lines; in a case where the average values corresponding to two candidate lateral fitting reference lines among the plurality of candidate lateral fitting reference lines have the same sign, determine that the two candidate lateral fitting reference lines are located at the same side of the container handling device, and determine the lateral fitting reference line from the two candidate lateral fitting reference lines; in a case where the average values corresponding to two candidate lateral fitting reference lines among the plurality of candidate lateral fitting reference lines have opposite signs, determine that the two candidate lateral fitting reference lines are located at different sides of the container handling device, respectively, and determine the two candidate lateral fitting reference lines as the lateral fitting reference lines.

In some embodiments, the first determining module 506 is further configured to determine a second region of interest from the target environment identification information; in a case where at least two to-be-identified position points exist in the second region of interest, determine the to-be-identified position points located in the second region of interest as second initial position points; in a case where a numeric count of the second initial position points is two, determine the longitudinal fitting reference line according to a line connecting the two second initial position points; in a case where the numeric count of the second initial position points is greater than two, determine the longitudinal fitting reference line by a linear fitting algorithm according to respective longitudinal dimension values corresponding to the second initial position points.

In some embodiments, the second determining module 508 is further configured to, in a case where the numeric count of the target position point is four, determine a perimeter of a geometric figure composed of the four target position points according to target position information corresponding to the four target position points; in a case where the perimeter of the geometric figure meets a preset perimeter, determine that the container handling device is in a lane region; in a case where the perimeter of the geometric figure does not meet the preset perimeter, determine that the container handling device is in a crossroad region, where the target environment information includes the lane region and the crossroad region.

In some embodiments, the second determining module 508 is further configured to, in a case where the numeric count of the target position point is two, obtain a travel direction of the container handling device; based on the travel direction of the container handling device and target position information corresponding to the two target position points, determine a positional relationship between each of the two target position points and the container handling device; in a case where both of the two target position points are located at one side of the container handling device, determine that the container handling device is in a single-side region; in a case where both of the two target position points are located in front of the container handling device, determine that the container handling device is in an entry region; in a case where both of the two target position points are located behind the container handling device, determine that the container handling device is in an exit region. The target environment information includes the single-side region, the entry region and the exit region.

In some embodiments, the second determining module 508 is further configured to, in a case where the target position point is not obtained or the numeric count of the target position point is one, determine that the container handling device is in an open region, where the target environment information includes the open region.

In some embodiments, the third determining module 510 is further configured to, in a case where the target environment information is a crossroad region or an open region, determine that the container handling device is rotatable at the current position; in a case where the target environment information is a lane region or a single-side region, determine that the container handling device is not rotatable at the current position; in a case where the target environment information is an entry region or an exit region, determine a target distance between the container handling device and a line connecting two target position points; and determine that the container handling device is rotatable at the current position in a case where the target distance is greater than a rotation radius of the container handling device; or determine that the container handling device is not rotatable at the current position in a case where the target distance is less than the rotation radius of the container handling device.

The device control apparatus based on the environment information provided in the embodiments of the present disclosure is applied to the container handling device. The apparatus includes the collecting module configured to, in response to the received environment information identification instruction, collect the initial environment identification information corresponding to the container handling device, where the container handling device is located in the inventory region, and the initial environment identification information is the point cloud data information corresponding to the inventory region; the filtering module configured to filter the initial environment identification information to obtain the target environment identification information, where the target environment identification information includes to-be-identified position points; the first determining module configured to determine the target position point among the to-be-identified position points and the target position information corresponding to the target position point; the second determining module configured to determine the target environment information corresponding to the container handling device according to the numeric count of the target position point and the target position information corresponding to the target position point, where the target environment information is configured to indicate the type of region corresponding to the current position of the container handling device in the inventory region; and the third determining module configured to determine whether the container handling device is rotatable at the current position according to the target environment information.

With the device control apparatus based on the environment information provided by the embodiments of the present disclosure, by collecting the initial environment identification information of the container handling device in the inventory region, the target position point and its corresponding target position information in the initial environment identification information are determined, and the target environment information of the container handling device is further determined. By identifying the target environment information of the container handling device, it is determined whether the container handling device is rotatable in the corresponding target environment, thereby compensating for the deficiency of the container handling device performing a single rotation in actual applications, effectively improving the safety of the container handling device when performing the rotation action, and further improving the stability and safety of the operation.

The above embodiments refer to a schematic scheme of the device control apparatus based on the environment information. It should be noted that the technical scheme of the device control apparatus based on the environment information and the technical scheme of the device control method based on the environment information belong to the same concept, and the details not described in the technical scheme of the device control apparatus based on the environment information can be referred to the description of the technical scheme of the device control method based on the environment information.

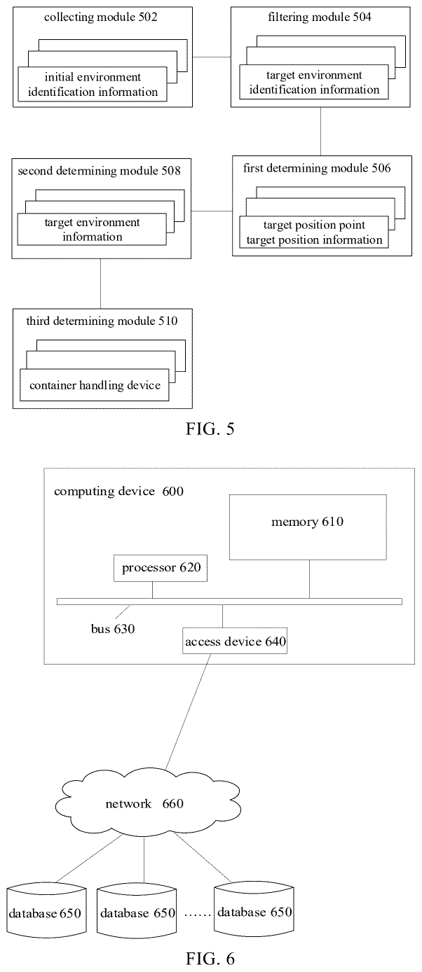

FIG. 6 is a block diagram showing a computing device provided in an embodiment of the present disclosure. Components of a computing device 600 include, but are not limited to a memory 610 and a processor 620. The processor 620 is connected to the memory 610 via a bus 630, and a database 650 is configured to store data.

In some embodiments, the computing device 600 further includes an access device 640 that enables the computing device 600 to communicate via one or more networks 660. Examples of these networks include a public switched telephone network (PSTN), a local region network (LAN), a wide region network (WAN), a personal region network (PAN) or a combination of communication networks such as Internet. The access device 640 may include one or more of any type of wired or wireless network interface (e.g., a network interface controller (NIC)), such as an IEEE802.11 wireless local region network (WLAN) wireless interface, a world interoperability for microwave access (Wi-MAX) interface, an Ethernet interface, a universal serial bus (USB) interface, a cellular network interface, a Bluetooth interface, a near field communication (NFC) interface, and so on.

In some embodiments of the present disclosure, the above components of the computing device 600 and other components not shown in FIG. 6 may be connected to each other, for example, via a bus. It is to be understood that the block diagram of the computing device shown in FIG. 6 is only for illustrative purposes, and is not intended to limit the scope of the present disclosure. Those skilled in the art may add or replace other components as needed.

In some embodiments, the computing device 600 may be any type of stationary or mobile computing device, including a mobile computer or a mobile computing device (e.g., a tablet computer, a personal digital assistant, a laptop computer, a notebook computer, a netbook, etc.), a mobile phone (e.g., a smart phone), a wearable computing device (e.g., a smart watch, a smart glass, etc.) or other types of mobile devices, or a stationary computing device such as a desktop computer or a personal computer (PC). It is also possible for the computing device 600 to be a mobile or stationary server.

The processor 620 is configured to execute computer-executable instructions of the device control method based on the environment information.

The above is a schematic solution of the computing device of the embodiment. It is to be noted that the technical solution of the computing device and the technical solution of the above-mentioned device control method based on the environment information belong to a same concept, and details not described in the technical solution of the computing device may be referred to the description of the technical solution of the above-mentioned device control method based on the environment information.

An embodiment of the present disclosure further provides a computer-readable storage medium having stored therein computer instructions that, when executed by a processor, cause the processor to implement steps of the device control method based on the environment information.

The above is a schematic solution of a computer-readable storage medium of the embodiment. It is to be noted that the technical solution of the storage medium and the technical solution of the above-mentioned device control method based on the environment information belong to a same concept, and details not described in the technical solution of the storage medium may be referred to the description of the technical solution of the above-mentioned device control method based on the environment information.

The above describes specific embodiments of the present disclosure. Some embodiments are within the scope of the appended claims. In some cases, the operations or steps recorded in the claims may be performed in an order different from that in the embodiments and still achieve the desired results. In addition, it is not necessary for the operations depicted in the accompanying drawings to be performed in a specific order or continuously to achieve the desired results. In some embodiments, multitasking processing and parallel processing are also possible or may be advantageous.

It is to be noted that for the sake of simplicity of description, the above-mentioned method embodiments are all described as a series of action/operation combinations, but those skilled in the art should know that the present disclosure is not limited by a described order of actions. Some steps may be performed in other orders or simultaneously according to the present disclosure. Secondly, those skilled in the art should also know that the embodiments described herein are all preferred embodiments, and actions and modules involved are not all necessarily required by the present disclosure.

In the above-mentioned embodiments, the description of each embodiment has its own emphasis. For parts that are not described in detail in a certain embodiment, reference may be made to relevant descriptions of other embodiments.

The preferred embodiments of the present disclosure disclosed above are only used to help illustrate the present disclosure. Alternative embodiments do not describe all the details in detail, nor do they limited the present disclosure to the specific embodiments described. Many modifications and changes may be made according to the contents of the present disclosure. The present disclosure selects and specifically describes these embodiments in order to better explain the principle and practical application of the present disclosure, so that those skilled in the art may understand and utilize the present disclosure well. The present disclosure is limited only by the claims and their full scope and equivalents.

1. A device control method based on environment information, performed by a container handling device, comprising:
in response to a received environment information identification instruction, collecting initial environment identification information corresponding to the container handling device, wherein the container handling device is located in an inventory region, and the initial environment identification information is point cloud data information corresponding to the inventory region;
filtering the initial environment identification information to obtain target environment identification information, wherein the target environment identification information comprises to-be-identified position points;
determining a target position point among the to-be-identified position points and target position information corresponding to the target position point;
determining target environment information corresponding to the container handling device according to a numeric count of the target position point and the target position information corresponding to the target position point, wherein the target environment information is configured to indicate a type of region corresponding to a current position of the container handling device in the inventory region; and
determining whether the container handling device is rotatable at the current position according to the target environment information.

2. The method according to claim 1, wherein in response to the received environment information identification instruction, collecting the initial environment identification information corresponding to the container handling device comprises:
determining an environment collection parameter in the environment information identification instruction, wherein the environment collection parameter is configured to indicate to the container handling device a collection range in the inventory region; and
determining, according to the environment collection parameter, the initial environment identification information corresponding to the container handling device.

3. The method according to claim 2, wherein determining, according to the environment collection parameter, the initial environment identification information corresponding to the container handling device comprises:
determining, according to the environment collection parameter, point cloud data information corresponding to the container handling device; and
mapping the point cloud data information corresponding to the container handling device to a rectangular coordinate system with the container handling device as an origin, to obtain the initial environment identification information.

4. The method according to claim 1, wherein filtering the initial environment identification information to obtain the target environment identification information comprises:
clustering the point cloud data information corresponding to the inventory region to obtain an initial cluster set, wherein the initial cluster set comprises a plurality of clusters, each of which comprises at least one point;
determining an abnormal cluster among the plurality of clusters in the initial cluster set, and removing the abnormal cluster from the initial cluster set to obtain a target cluster set;
determining a mass center of each target cluster in the target cluster set, and position information corresponding to the mass center of each target cluster; and
determining the mass center of each target cluster as a to-be-identified position point, and determining the position information corresponding to the mass center of each target cluster as the position information of the to-be-identified position point.

5. The method according to claim 4, wherein determining the abnormal cluster in the initial cluster set comprises:
determining a numeric count of points comprised in each cluster in the initial cluster set; and
determining a cluster in which a numeric count of points is less than a preset number as the abnormal cluster.

6. The method according to claim 4, wherein determining the abnormal cluster among the plurality of clusters in the initial cluster set comprises:
determining, among the plurality of clusters comprised in the initial cluster set, a cluster whose cluster diameter is larger than a preset diameter as the abnormal cluster;
and/or determining an Euclidean distance between any two points in each cluster, and determining, among the plurality of clusters comprised in the initial cluster set, a cluster corresponding to two points between which an Euclidean distance is greater than a preset threshold as the abnormal cluster.

7. The method according to claim 1, wherein determining the target position point among the to-be-identified position points and the target position information corresponding to the target position point comprises:
determining a lateral fitting reference line and a longitudinal fitting reference line according to the to-be-identified position point; and
determining an intersection point of the lateral fitting reference line and the longitudinal fitting reference line as the target position point, and determining position information corresponding to the intersection point as the target position information.

8. The method according to claim 7, wherein determining the lateral fitting reference line according to the to-be-identified position point comprises:
determining a first region of interest from the target environment identification information;
determining a to-be-identified position point located in the first region of interest as a first initial position point in a case where the to-be-identified position point exists in the first region of interest;
determining a longitudinal dimension value of the first initial position point; and
determining the lateral fitting reference line according to the longitudinal dimension value of the first initial position point.

9. The method according to claim 8, wherein determining the lateral fitting reference line according to the longitudinal dimension value of the first initial position point comprises:
in a case where a numeric count of the first initial position point is one, determining the lateral fitting reference line according to the longitudinal dimension value of the first initial position point; and
in a case where the numeric count of the first initial position point is at least two, determining at least one lateral fitting reference line according to longitudinal dimension values of the at least two first initial position points.

10. The method according to claim 9, wherein determining the at least one lateral fitting reference line according to the longitudinal dimension values of the at least two first initial position points comprises:
ranking the longitudinal dimension value corresponding to each of the at least two first initial position points;
determining a difference between longitudinal dimension values of two adjacent first initial position points according to the longitudinal dimension values of the two adjacent first initial position points;
in a case where the difference between the longitudinal dimension values is greater than a preset difference, adding the two adjacent first initial position points to two different lateral fitting coordinate point sets, respectively;
in a case where the difference between the longitudinal dimension values is less than or equal to the preset difference, adding the two adjacent first initial position points to the same lateral fitting coordinate point set; and
determining the lateral fitting reference line according to each lateral fitting coordinate point set.

11. The method according to claim 10, wherein determining the lateral fitting reference line according to each lateral fitting coordinate point set comprises:
determining a target lateral fitting coordinate point set according to each lateral fitting coordinate point set;
obtaining respective longitudinal dimension values of first initial position points in the target lateral fitting coordinate point set;
determining an average value of the longitudinal dimension values of the first initial position points according to the longitudinal dimension values of the first initial position points; and
determining the lateral fitting reference line corresponding to the target lateral fitting coordinate point set according to the average value.

12. The method according to claim 11, wherein determining the lateral fitting reference line corresponding to the target lateral fitting coordinate point set according to the average value comprises:
generating a candidate lateral fitting reference line according to the average value;
in a case where a plurality of candidate lateral fitting reference lines are generated, obtaining average values corresponding to the plurality of candidate lateral fitting reference lines;
in a case where the average values corresponding to two candidate lateral fitting reference lines among the plurality of candidate lateral fitting reference lines have the same sign, determining that the two candidate lateral fitting reference lines are located at the same side of the container handling device, and determining the lateral fitting reference line from the two candidate lateral fitting reference lines; and
in a case where the average values corresponding to two candidate lateral fitting reference lines among the plurality of candidate lateral fitting reference lines have opposite signs, determining that the two candidate lateral fitting reference lines are located at different sides of the container handling device, respectively, and determining the two candidate lateral fitting reference lines as the lateral fitting reference lines.

13. The method according to claim 7, wherein determining the longitudinal fitting reference line according to the to-be-identified position point comprises:
determining a second region of interest from the target environment identification information;
in a case where at least two to-be-identified position points exist in the second region of interest, determining the to-be-identified position points located in the second region of interest as second initial position points;
in a case where a numeric count of the second initial position points is two, determining the longitudinal fitting reference line according to a line connecting the two second initial position points; and
in a case where the numeric count of the second initial position points is greater than two, determining the longitudinal fitting reference line by a linear fitting algorithm according to respective longitudinal dimension values corresponding to the second initial position points.

14. The method according to claim 1, wherein determining the target environment information corresponding to the container handling device according to the numeric count of the target position point and the target position information corresponding to the target position point comprises:
in a case where the numeric count of the target position point is four, determining a perimeter of a geometric figure composed of the four target position points according to target position information corresponding to the four target position points;
in a case where the perimeter of the geometric figure meets a preset perimeter, determining that the container handling device is in a lane region; and
in a case where the perimeter of the geometric figure does not meet the preset perimeter, determining that the container handling device is in a crossroad region, wherein the target environment information comprises the lane region and the crossroad region.

15. The method according to claim 1, wherein determining the target environment information corresponding to the container handling device according to the numeric count of the target position point and the target position information corresponding to the target position point comprises:
in a case where the numeric count of the target position point is two, obtaining a travel direction of the container handling device;
based on the travel direction of the container handling device and target position information corresponding to the two target position points, determining a positional relationship between each of the two target position points and the container handling device;
in a case where both of the two target position points are located at one side of the container handling device, determining that the container handling device is in a single-side region;
in a case where both of the two target position points are located in front of the container handling device, determining that the container handling device is in an entry region; and
in a case where both of the two target position points are located behind the container handling device, determining that the container handling device is in an exit region;
wherein the target environment information comprises the single-side region, the entry region and the exit region.

16. The method according to claim 1, wherein determining the target environment information corresponding to the container handling device according to the numeric count of the target position point and the target position information corresponding to the target position point comprises:
in a case where the target position point is not obtained or the numeric count of the target position point is one, determining that the container handling device is in an open region, wherein the target environment information comprises the open region.

17. The method according to claim 14, wherein determining whether the container handling device is rotatable according to the target environment information comprises:
in a case where the target environment information is a crossroad region or an open region, determining that the container handling device is rotatable at the current position;
in a case where the target environment information is a lane region or a single-side region, determining that the container handling device is not rotatable at the current position; and
in a case where the target environment information is an entry region or an exit region, determining a target distance between the container handling device and a line connecting two target position points; and determining that the container handling device is rotatable at the current position in a case where the target distance is greater than a rotation radius of the container handling device; or determining that the container handling device is not rotatable at the current position in a case where the target distance is less than the rotation radius of the container handling device.

18. The method according to claim 17, further comprising:
in a case where it is determined that the container handling device is rotatable at the current position, performing rotating at the current position; and
in a case where it is determined that the container handling device is not rotatable at the current position, generating alarm information and/or a fault instruction, wherein the fault instruction is configured to indicate that the container handling device is not rotatable at the current position.

19. (canceled)

20. A computing device comprising a memory, a processor and computer instructions stored on the memory and executable on the processor, wherein the processor is configured to:
in response to a received environment information identification instruction, collecting initial environment identification information corresponding to a container handling device, wherein the container handling device is located in an inventory region, and the initial environment identification information is point cloud data information corresponding to the inventory region;
filtering the initial environment identification information to obtain target environment identification information, wherein the target environment identification information comprises to-be-identified position points;
determining a target position point among the to-be-identified position points and target position information corresponding to the target position point;
determining target environment information corresponding to the container handling device according to a numeric count of the target position point and the target position information corresponding to the target position point, wherein the target environment information is configured to indicate a type of region corresponding to a current position of the container handling device in the inventory region; and
determining whether the container handling device is rotatable at the current position according to the target environment information.

21. A non-transitory computer-readable storage medium having stored therein computer instructions, wherein the computer instructions, when executed by a processor, cause the processor to perform:
in response to a received environment information identification instruction, collecting initial environment identification information corresponding to a container handling device, wherein the container handling device is located in an inventory region, and the initial environment identification information is point cloud data information corresponding to the inventory region;
filtering the initial environment identification information to obtain target environment identification information, wherein the target environment identification information comprises to-be-identified position points;
determining a target position point among the to-be-identified position points and target position information corresponding to the target position point;
determining target environment information corresponding to the container handling device according to a numeric count of the target position point and the target position information corresponding to the target position point, wherein the target environment information is configured to indicate a type of region corresponding to a current position of the container handling device in the inventory region; and
determining whether the container handling device is rotatable at the current position according to the target environment information.
